(19) United States
(12) Patent Application Publication
(10) Pub. No.: US 2004/0205191 A1
(43) Pub. Date: Oct. 14, 2004

(54) Method and apparatus for communicating with a computing device that is physically tagged

(76) Inventors: Randall B. Smith, Palo Alto, CA (US); Kristen A. McIntyre, Fremont, CA (US); Amit Goyal, Stone Mountain, GA (US); Jean-Paul Rene Wagner, Ehlange-sur-Mess (LU)

Correspondence Address: PARK, VAUGHAN & FLEMING LLP, 508 SECOND STREET, SUITE 201, DAVIS, CA, 95616, US

(21) Appl. No.: 10/386,748

(22) Filed: Mar. 11, 2003

(51) Int. Cl. G06F 15/16

(52) U.S. Cl. 709/227; 370/310

(57) ABSTRACT

One embodiment of the present invention provides a system that facilitates initiating a communication session with a computing device. The system operates by first detecting the presence of the computing device through a first communication channel, and then initiating a communication session between the computing device and a server through the second communication channel. Next, the system transfers the state of an existing communication session between the server and a client to the computing device through the second communication channel, so that the computing device can take over the existing communication session with the server in place of the client.

### BACKGROUND

1. Field of the Invention

The present invention relates to the process of managing communications sessions between computing devices. More specifically, the present invention relates to a method and an apparatus for communicating with a computing device that is physically tagged using a Radio Frequency ID (RFID) tag.

2. Related Art

Over the past decade, handheld computing devices have evolved from small calculator-like devices that can store a few contacts and other basic information to full-blown computer systems that mirror the functionality of desktop computer systems. During this same time period, handheld computing devices moved from obscurity to become commonly used business tools. Personal Digital Assistants (PDAs) and ultra-portable laptops presently number in the millions and have become a staple of modern business.

These mobile computing devices have brought many benefits to the workplace, such as increased productivity due to faster access to information. Many tasks that were historically performed at desktop computer systems in the office are now being performed everywhere using mobile computing devices.

Along with these benefits, however, the use of mobile computing devices has generated new problems. Users typically maintain the same information on both their desktop computer system and their mobile computing device. This can cause synchronization problems. If the same information is modified in both places before synchronization occurs, information can be lost if one copy is used to overwrite the other. Furthermore, users often do not synchronize their data regularly because they forget, or they do not want to take the time to initiate the synchronization process.

Maintaining network connectivity can also be a challenge for mobile computing devices. Numerous mechanisms exist to connect mobile computing devices to networks and other computing devices. As a mobile computing device is moved from one place to another, users often you have to reconfigure some parameters within the mobile computing device to allow the device to maintain network connectivity in the new environment. Furthermore, depending on characteristics of the network itself, it can be difficult to locate and connect to the desired resources.

What is needed is a method and an apparatus for facilitating communications with a mobile computing device without the limitations listed above.

### SUMMARY

One embodiment of the present invention provides a system that facilitates communicating with a computing device that is physically tagged with a Radio Frequency ID (RFID) tag. During operation, an RFID tag reader detects the presence of the RFID tag, which is coupled to the computing device. In response to detecting the presence of the RFID tag, the system broadcasts the RFID over a network so that devices on the network know that the computing device is in proximity to the RFID tag reader. The system then receives a request from a server to initiate a communication session with the computing device, wherein the server is preconfigured to initiate a communication session with the computing device upon receiving a broadcast of the RFID on the network. In response to the request from the server, the system facilitates a communication session between the computing device and the server.

In a variation on this embodiment, the system transfers an existing communication session between the server and a client to the computing device by first initiating the communication session between the server and the computing device. Next, the system transfers the state of the existing communication session to the computing device, so that the computing device can take over the existing communication session with the server in place of the client. Finally the system terminates the existing communication session with the client.

In a further variation on this embodiment, the system detects the absence of the RFID tag, which indicates that the computing device has moved out of the range of the RFID tag reader. In this case, the system then initiates a new communication session between the client and the server. The system also transfers the state of the communication session between the computing device and the server to the new communication session, and terminates the communication session between the server and the computing device.

In a variation on this embodiment, the system facilitates a communication session between the computing device and the server by transferring data between the computing device and the server, wherein the server is a computing device that is in close proximity to the RFID tag reader.

In a further variation on this embodiment, the system synchronizes files between the computing device and the server.

In yet a further variation on this embodiment, the system synchronizes Personal Information Manager (PIM) information between the computing device and the server.

In a further variation on this embodiment, the presence of the RFID tag is detected on a channel that is separate from a channel carrying the communication session between the computing device and the server.

One embodiment of the present invention provides a system that facilitates initiating a communication session with a computing device. The system operates by first detecting the presence of the computing device through a first communication channel, and then initiating a communication session between the computing device and a server through the second communication channel. Next, the system transfers the state of an existing communication session between the server and a client to the computing device through the second communication channel, so that the computing device can take over the existing communication session with the server in place of the client.

### BRIEF DESCRIPTION OF THE FIGURES

FIG. 1 illustrates a computer network in accordance with an embodiment of the present invention.

FIG. 2 presents a flowchart illustrating the process of facilitating a communication session with a computing device in accordance with an embodiment of the present invention.

FIG. 3 presents a flowchart illustrating the process of transferring a session to the computing device in accordance with an embodiment of the present invention.

FIG. 4 presents a flowchart illustrating the process of transferring a session from the computing device in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer Network

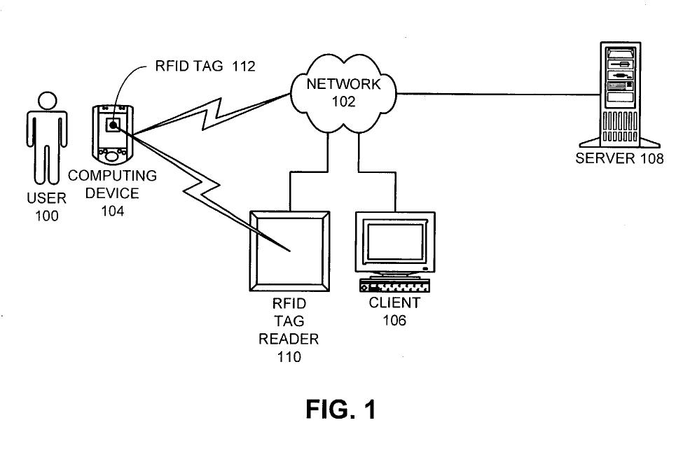

FIG. 1 illustrates computer network 102 in accordance with an embodiment of the present invention. Network 102 can generally include any type of wire or wireless communication channel capable of coupling together computing nodes. This includes, but is not limited to, a local area network, a wide area network, or a combination of networks. In one embodiment of the present invention, network 102 includes the Internet.

Computing device 104 is coupled to network 102 via a wired or a wireless connection. Computing device 104 can generally include any type of computer system, including, but not limited to, a computer system based on a microprocessor, a mainframe computer, a digital signal processor, a portable computing device, a personal organizer, a device controller, and a computational engine within an appliance. User 100 interacts with network 102 and other devices attached to network 102 via computing device 104.

Client 106 and server 108 are also coupled to network 102. Client 106 can generally include any node on a network including computational capability and including a mechanism for communicating across network 102. Server 108 can generally include any computational node including a mechanism for servicing requests from a client for computational and/or data storage resources. Note that in one embodiment of the present invention, client 106 can also act as a server.

Located in close proximity to client 106 is Radio Frequency ID (RFID) tag reader 110. RFID tag reader 110 is coupled to network 102, and can detect the presence of RFID tags, such as RFID tag 112, which is attached to computing device 104.

Facilitating a Communications Session

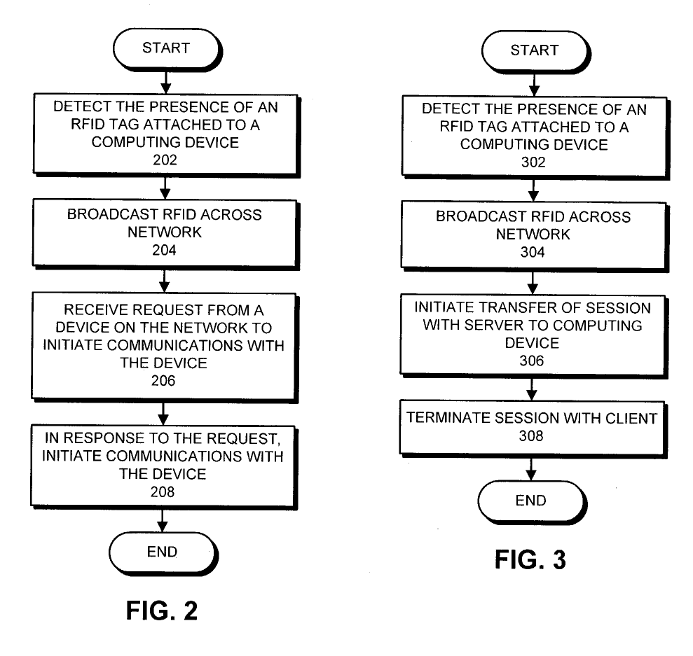

FIG. 2 presents a flowchart illustrating the process of facilitating a communication session with computing device 104 in accordance with an embodiment of the present invention. The process starts when RFID tag reader 110 detects the presence of RFID tag 112, which is attached to computing device 104 (step 202).

When RFID tag reader 110 detects the presence of RFID tag 112, RFID tag reader broadcasts the RFID over network 102 (step 204). In the embodiment shown in FIG. 1, the broadcast is a multicast transmission to all devices coupled to network 102. Note that RFID tag reader 110 can also be pre-configured to broadcast some other information or unique identifier representing the RFID (instead of broadcasting the RFID itself) upon detecting the presence of RFID tag 112.

Upon receiving the broadcast of the RFID from RFID tag reader 110, client 106 sends a request to computing device 104 to initiate a communication session between client 106 and computing device 104. Computing device 104 subsequently receives the request (step 206), and in response to the request, initiates a communication session between computing device 104 and client 106 (step 208).

The communication session between computing device 104 and client 106 can convey information used to perform many different tasks, such as transferring a control session with server 108 from client 106 to computing device 104, synchronizing data between computing device 104 and client 106, or redirecting the output of a video stream from client 106 to computing device 104.

In another embodiment of the present invention, devices that have no computational ability can be tagged with RFID tags and can represent actions. For example, a paperweight with an RFID tag can be moved into a conference room that contains an RFID tag reader. Upon detecting the presence of the RFID tag attached to the paperweight, the system can adjust the lighting, music, and HVAC settings in the conference room to pre-determined settings that are represented by the paperweight. Additionally, the presence of the RFID tag can initiate the loading and display of pre-specified presentation material.

Transferring a Session to the Computing Device

FIG. 3 presents a flowchart illustrating the process of transferring a session to computing device 104 in accordance with an embodiment of the present invention. As user 100 moves from location to location with computing device 104, it may be desirable for an active session between server 108 and client 106 to be transferred from client 106 to computing device 104. The process starts when RFID tag reader 110 detects the presence of RFID tag 112 that is attached to computing device 104 (step 302). When RFID tag reader 110 detects the presence of RFID tag 112, RFID tag reader broadcasts the RFID over network 102 (step 304).

Upon receiving the broadcast of the RFID, server 108 initiates a transfer of a session with client 106 to computing device 104 (step 306). In transferring the session from client 106 to computing device 104, the control and output of every process running on server 108 that is associated with the session is transferred to computing device 104. Optionally, other information can be transferred from client 106 to computing device 104, such as the cut and paste buffer on client 106. Finally, once the transfer is complete, the session between server 108 and client 106 is terminated (step 308).

Transferring a Session from the Computing Device

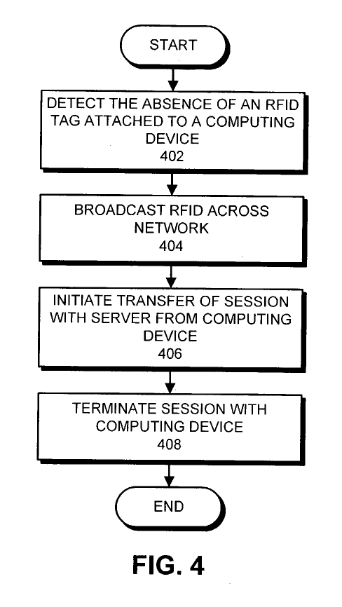

FIG. 4 presents a flowchart illustrating the process of transferring a session from computing device 104 to client 106 in accordance with an embodiment of the present invention. When user 100 moves computing device 104 out of range of RFID tag reader 110, it may be desirable to perform pre-determined actions, such as transferring a session with server 108 to client 106 from computing device 104.

The process starts when RFID tag reader 110 detects the absence of RFID tag 112 that is attached to computing device 104 (step 402). This occurs when computing device 104 moves outside of RFID tag reader 110's range of sensitivity. When RFID tag reader 110 no longer detects the presence of RFID tag 112, RFID tag reader 112 broadcasts the RFID over network 102 (step 404). Alternatively, RFID tag reader 110 can be configured to continually broadcast the RFID over network 102 and pre-determined intervals while RFID tag 112 is present, and to cease broadcasting the RFID over network 102 when RFID tag reader 110 detects the absence of RFID tag 112.

Upon receiving the broadcast of the RFID, server 108 initiates a transfer of the session with computing device 104 back to client 106 (step 406). In transferring the session from computing device 104 to client 106, the control and output of every process running on server 108 that is associated with the session is transferred to client 106. Optionally, other information can be transferred from computing device 104 to client 106, such as the cut and paste buffer on computing device 104. Finally, once the transfer is complete, the session between server 108 and computing device 104 is terminated (step 408).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for communicating with a computing device that is physically tagged with a Radio Frequency ID (RFID) tag, comprising:
detecting the presence of the RFID tag which is coupled to the computing device, wherein the presence is detected at an RFID tag reader;
broadcasting the RFID over a network so that devices on the network know that the computing device is in proximity to the RFID tag reader;
receiving a request from a server to initiate a communication session with the computing device, wherein the server is preconfigured to initiate a communication session with the computing device upon receiving a broadcast of the RFID on the network; and
in response to the request from the server, facilitating a communication session between the computing device and the server.

2. The method of claim 1, wherein facilitating the communication session between the computing device and the server involves transferring an existing communication session between the server and a client to the computing device by:
initiating the communication session between the server and the computing device;
transferring the state of the existing communication session to the communication session, so that the computing device can take over the existing communication session with the server in place of the client; and
terminating the existing communication session with the client.

3. The method of claim 2, further comprising:
detecting the absence of the RFID tag at the RFID tag reader;
initiating a new communication session between the client and the server;
transferring the state of the communication session between the computing device and the server to the new communication session; and
terminating the communication session between the server and the computing device.

4. The method of claim 1, wherein facilitating a communication session between the computing device and the server further comprises transferring data between the computing device and the server, wherein the server is a computing device that is in close proximity to the RFID tag reader.

5. The method of claim 4, wherein transferring data further involves synchronizing files.

6. The method of claim 5, wherein synchronizing files further involves synchronizing Personal Information Manager (PIM) information between the computing device and the server.

7. The method of claim 1, wherein the presence of the RFID tag is detected on a channel that is separate from a channel carrying the communication session between the computing device and the server.

8. A computer-readable storage medium storing instructions that when executed by a computer cause the computer to perform a method for communicating with a computing device that is physically tagged with a Radio Frequency ID (RFID) tag, the method comprising:
detecting the presence of the RFID tag which is coupled to the computing device, wherein the presence is detected at an RFID tag reader;
broadcasting the RFID over a network so that devices on the network know that the computing device is in proximity to the RFID tag reader;
receiving a request from a server to initiate a communication session with the computing device, wherein the server is preconfigured to initiate a communication session with the computing device upon receiving a broadcast of the RFID on the network; and
in response to the request from the server, facilitating a communication session between the computing device and the server.

9. The computer-readable storage medium of claim 8, wherein facilitating the communication session between the computing device and the server involves transferring an existing communication session between the server and a client to the computing device by:
initiating the communication session between the server and the computing device;
transferring the state of the existing communication session to the communication session, so that the computing device can take over the existing communication session with the server in place of the client; and
terminating the existing communication session with the client.

10. The computer-readable storage medium of claim 9, further comprising:
detecting the absence of the RFID tag at the RFID tag reader;
initiating a new communication session between the client and the server;
transferring the state of the communication session between the computing device and the server to the new communication session; and
terminating the communication session between the server and the computing device.

11. The computer-readable storage medium of claim 8, wherein facilitating a communication session between the computing device and the server further comprises transferring data between the computing device and the server, wherein the server is a computing device that is in close proximity to the RFID tag reader.

12. The computer-readable storage medium of claim 11, wherein transferring data further involves synchronizing files.

13. The computer-readable storage medium of claim 12, wherein synchronizing files further involves synchronizing Personal Information Manager (PIM) information between the computing device and the server.

14. The computer-readable storage medium of claim 8, wherein the presence of the RFID tag is detected on a channel that is separate from a channel carrying the communication session between the computing device and the server.

15. An apparatus for communicating with a computing device that is physically tagged with a Radio Frequency ID (RFID) tag, comprising:
a detection mechanism configured to detect the presence of the RFID tag which is coupled to the computing device, wherein the presence is detected at an RFID tag reader;
a broadcast mechanism configured to broadcast the RFID over a network so that devices on the network know that the computing device is in proximity to the RFID tag reader;
a receiving mechanism configured to receive a request from a server to initiate a communication session with the computing device, wherein the server is preconfigured to initiate a communication session with the computing device upon receiving a broadcast of the RFID on the network; and
a communications mechanism configured to facilitate a communication session between the computing device and the server in response to the request from the server.

16. The apparatus of claim 15, wherein the communications mechanism is further configured to transfer an existing communication session between the server and a client to the computing device by:
initiating the communication session between the server and the computing device;
transferring the state of the existing communication session to the communication session, so that the computing device can take over the existing communication session with the server in place of the client; and
terminating the existing communication session with the client.

17. The apparatus of claim 16, wherein the detection mechanism is further configured to detect the absence of the RFID tag at the RFID tag reader, and wherein the communications mechanism is further configured to:
initiate a new communication session between the client and the server;
transfer the state of the communication session between the computing device and the server to the new communication session; and to
terminate the communication session between the server and the computing device.

18. The apparatus of claim 15, wherein the communications mechanism is further configured to transfer data between the computing device and the server, wherein the server is a computing device that is in close proximity to the RFID tag reader.

19. The apparatus of claim 18, wherein the communications mechanism is further configured to transferring synchronize files.

20. The apparatus of claim 19, wherein the communications mechanism is further configured to synchronize Personal Information Manager (PIM) information between the computing device and the server.

21. The apparatus of claim 15, wherein the communications mechanism facilitates the communication session between the computing device and the server on a channel that is separate from a channel on which the detection mechanism detects the presence of the RFID tag.

22. A method for initiating a communication session with a computing device, comprising:
detecting the presence of the computing device through a first communication channel;
initiating a communication session between the computing device and a server through the second communication channel; and
transferring the state of an existing communication session between the server and a client to the computing device through the second communication channel, so that the computing device can take over the existing communication session with the server in place of the client.

23. The method of claim 22, wherein detecting the presence of the computing device through the first communication channel involves detecting the presence of the RFID tag which is coupled to the computing device, wherein the presence is detected at an RFID tag reader.

24. The method of claim 23, further comprising:
detecting the absence of the RFID tag at the RFID tag reader;
initiating a new communication session between the client and the server;
transferring the state of the communication session between the computing device and the server to the new communication session; and
terminating the communication session between the server and the computing device.

25. The method of claim 22, initiating the communication session between the computing device and the server through the second communication channel further comprises transferring data between the computing device and the server, wherein the server is a computing device that is in close proximity to the RFID tag reader.

26. The method of claim 25, wherein transferring data further involves synchronizing files.

27. The method of claim 26, wherein synchronizing files further involves synchronizing Personal Information Manager (PIM) information between the computing device and the server.
